(19) United States
(12) Patent Application Publication
(10) Pub. No.: US 2016/0310830 A1
(43) Pub. Date: Oct. 27, 2016

(54) CASINO-TABLE WAGERING EVENT BASED ON TEXAS HOLDEM

(71) Applicant: Jeffery Hwang, Henderson, NV (US)

(72) Inventor: Jeffery Hwang, Henderson, NV (US)

(21) Appl. No.: 14/692,683

(22) Filed: Apr. 21, 2015

(51) Int. Cl. A63F 1/00; G07F 17/32

(52) U.S. Cl. CPC A63F 1/00; G07F 17/3293; G07F 17/3244; A63F 2001/005

(57) ABSTRACT

A method of performing a wagering event modifies a Texas Hold'Em game at a gaming table. A player position two-card hole cards competes with a dealer position two-card hole cards. Five community cards are used as in Texas Hold'Em. Player wagers are placed at various stages of display of community cards to have the event continue. Failure to make player wagers at any time causes the game to end. All wagers are resolved in competition with the position hand. There is a controlling dealer hand rank requirement.

### BACKGROUND OF THE INVENTION

1. Field of the Invention

The present invention relates to wagering events and particularly poker-based wagering events and stud poker-based events using a variant of 7-card stud Poker.

2. Background of the Art

The use of poker games as casino table games and as competitive card room games has undergone a significant resurgence in the past twenty years. Both video game versions, live table physical playing card versions, electronic gaming table versions and mixed physical and electronic systems have been used with many variations of poker. Among the more successful games are video draw poker (and its multiline variations), Three-Card Poker™ game, Four-Card Poker™ game, Texas Hold-'Em, Omaha poker, and the like.

Although both Texas Hold-'Em and Omaha Poker are very successful in card room environments, only Texas Hold-'Em has found any success in casino-banked variants or developed any new successful variants. Among the variants are those described below.

Published US Patent Application Document No. 20060284376 (Snow) describes a variant game of Hold'Em poker that allows for rules of play of one or all of Players being allowed to remain in game with an option of checking or making specific wagering amounts in first Play wagers, being limited in the size of subsequent available Play wagers or prohibited from making additional Play wagers if a first Play wager has been made, being limited in the size of available later Play wagers if a first or earlier Play wager has been made, and having the opportunity for at least two and as many as three or four distinct opportunities in the stages in the play of hand to be able to make one or more Play wagers.

Published US Patent Application Document No. 20090124315 (Snow) describes a wagering game methods and apparatus for playing a Draw Poker type live casino and/or electronic game against a dealer and/or a pay table. Players place an ante wager to participate in the game. Each player and the dealer are dealt initial hands. Each player may discard any portion including all of his or her cards. The dealer discards according to predetermined criteria. Discarded cards are replaced by community draw cards in a specified order to complete final hands. Alternatively, each player and the dealer may be dealt their initial hands and replacement cards from their own associated decks. The ante wager is paid if the player's final hand outranks the dealer's final hand. An optional ante wager is paid according to a paytable if the player's final hand achieves at least a minimum bonus qualifying rank.

U.S. Pat. No. 6,581,936 (Zoccolillo) describes a casino card gaming method utilizing a conventional fifty-two card deck and begins by first determining the players for a given round. Players may elect to be eligible for receiving a bonus card. The individual players' hands, a set of common cards and a bonus card for players eligible for the bonus card are dealt. Players which continue through the round determine whether to play the hand as dealt or to utilize the common cards. Players utilizing the common cards discard a number of cards from their hands equal to the number of common cards. The relative ranking of the final hands for the players is determined with the relative ranking based upon the statistical likelihood of obtaining predetermined combinations of cards.

More variations in wagering games are desirable, especially as it is difficult to convert known wagering events such as poker games into casino table games that are easy to understand, easy to administer by the casino and yet offer reasonable numbers of winning events and opportunities to players. One of the significant successful stud poker games is Mississippi Stud™ poker. Mississippi Stud Poker is a popular table game known throughout the world but is especially popular in casinos surrounding the state its named after. While it won't take you very long to learn how to play Mississippi Stud Poker, it will take some time to develop and remember strategies.

Mississippi Stud Poker is played on traditional card tables, and is similar to Texas Hold'em, but has its own unique twists. The game begins with each player making an ante wager. After players ante up, they are each dealt two cards, face down. The dealer then will put three community cards face down in the middle of the table. These will be revealed at a later time, Players can either fold at this point or continue to play. However if the decide to continue to play, they must wager three times their original ante bet to complete the hand and collect their winnings.

If the players decide to keep playing after seeing their original cards, they must wager in the table's first circle called “Third Street.” The wager must equal the ante, though it can be up to three times the amount of the ante bet. This is when the dealer shows the first community card. Now that the remaining players can see the community card, they can both fold and lose the money that they've bet thus far, or they can wager again, up to three times their original ante bet. If the players continue to play, their wagers are placed in the “Fourth Street” circle on the table. That's when the dealer reveals the second community card.

Once the second community card has been revealed, players can fold and lose all the money that they have bet or they can once again bet up to three times the original ante bet. If they decide to wager again, the money is placed in a circle on the table known as “Fifth Street.” This ends the chance to wager for the current hand, Now, the dealer reveals the final community card.

A player who has either a five card hand or at minimum of a pair of six's will not be a loser. Any pair of cards six through ten represents a push whereby the player wins back all of his wagers that he made throughout the entire hand. He then starts the next hand out with a new ante bet. Players with five card hands can win big money, especially if their hands are of the “higher” sort. The highest payout is a Royal Flush at 500 to 1. A Straight Flush comes next at 100 to 1. Four of a kind pays 40 to 1, A full house provides 10 to 1. A flush is 6 to 1. A straight is 4 to 1. Three of a kind is 3 to 1. Two pairs is paid at 2 to 1. A pair of jacks or higher is a 1 to payout.

To date, all casino Texas Hold'em variants to make significant impact on the casino floor have one of four things in common, most of which run contrary to actual Texas Hold'em play:

Without exception, these games have placed an undue emphasis on pre-flop betting. The largest wagers appear pre-flop, whereas in real poker, the bets get bigger as the hand progresses and the pot gets bigger. None of these games present a meaningful bet-or-fold decision on the flop. Any dealer qualifiers relate to the ante wagers, and not to the play wagers.

### Ultimate Texas Hold'Em

In Ultimate Texas Hold'em, the player places two forced wagers—an Ante and equal Blind wager—and has three opportunities to make a single wager. The player may:
Bet 3× or 4× pre-flop, or
Bet 2× on the flop, or
Bet 1× on the river
   Indeed, the largest wagering opportunity in Ultimate Texas Hold'em occurs pre-flop, while the allowed bet sizes decrease as the hand progresses. Moreover, the only bet-or-fold decision occurs on the river, as the player is allowed to check the hand down to the river before being forced to bet, or otherwise forfeit his Ante and Blind wagers.

When the player makes a Play wager, the dealer only plays and pays the Ante wager when the dealer makes a pair or better; however, the dealer plays against the Play wager (whether 4×, 3×, 2×, or 1×) regardless. This runs counter to real poker—and the original concept behind the use of qualifiers (as in Caribbean Stud® poker, and its predecessor Casino Poker, the latter which was invented by David Sklansky); that concept is that the dealer will only play against bigger wagers when the dealer holds a bigger hand.

### Texas Hold'Em Bonus™ Game

In Texas Hold'em Bonus™ game, the player makes an Ante wager, and must bet 2× the Ante or fold pre-flop (the Flop wager). If the player bets 2×, the player can then either check or bet 1× on the flop (the Turn wager), and can also either check or bet 1× on the turn (the River wager).

Again the largest wager occurs pre-flop, while the latter two optional wagers are smaller than the pre-flop wager. In addition, the only bet-or-fold decision the player faces is pre-flop; moreover, this decision is largely only a nominal one, as the player is correct to make the 2× wager on 95% of hands. The dealer plays against all wagers except the Ante; the player must make a straight or better in order for the Ante to pay.

World Poker Tour all-in Hold'Em™ Game (10× and 3× Variations)

There are two versions of World Poker Tour All-In Hold'Em™ game. In one variation, the player makes an Ante wager, and the player and dealer are dealt two hole cards. The player can then either bet 5× or 10× the Ante, or fold. If the player bets, the dealer examines his cards; if the dealer does not have a minimum qualifying hand the dealer will fold and pay the Ante wager but not any play wager. But if the dealer has a minimum qualifying hand, the dealer will “call” and deal out five community cards, and the best hand wins. There is no post-flop play in this game, and the player is correct to make a play wager 88.2% of hands. Moreover, this game requires knowledge of game theory to understand, as the correct strategy is to bet 10× on the best and many of the worst hands, while making the 5× bet size on the hands in between.

In another variation, the player can bet 3× the Ante or fold. In this version, the player is correct to bet 3× on 91.9% of hands. Again, there is no post-flop play.

Each game has its own appeal. However, there is room in the market for a game which more accurately captures the essence of standard Texas Hold'em poker.

### SUMMARY OF THE INVENTION

A method of performing a wagering event at a gaming table includes:
providing a randomized set of at least a single deck of at least 52 playing cards:
a player position at the gaming table posting an ante wager;
the player position posting the ante wager is dealt a first set of two playing cards from the randomized set of playing cards;
a dealer position is dealt a first set of two playing cards face-down;
a community card position on the gaming table is dealt five playing cards face-down;
the player position: a) makes a first play wager of at least 1× the ante wager or b) folds and the ante wager is forfeit to the dealer position, with the game ending;
upon making the play wager of a), three of the five community cards are revealed as a flop;
after the three of five community cards have been revealed the player position: c) makes a final play wager of at least 1× the ante wager or b) folds and both the ante wager and first play wager are forfeit to the dealer position, with the game ending;
upon making the play wager of c) remaining face-down ones of the five community cards are revealed as a flop, and the dealer position two face-down cards are revealed;
best five-of-seven poker hand rank including the player position first set of two playing cards and the five community cards is compared with the dealer position two playing cards and the five community cards are compared; and
i) if the five-card poker rank at the player position equals the five-card poker rank at the dealer position, at least one of the ante wager and the first play wager and the final play wager is a push,
ii) if the five-card poker rank at the player position exceeds the five-card poker rank at the dealer position, all of the ante wager, the first play wager and the final play wager are awarded as a winning outcome, and
iii) if the five-card poker rank at the player position is lower in rank than the five-card poker rank at the dealer position, all the ante wager and the play wager are collected by the dealer.

### BRIEF DESCRIPTION OF THE FIGURES

FIG. 1 (PRIOR ART) shows a standard video game apparatus useful in enabling the present technology.

FIG. 1A (PRIOR ART) shows a gaming network that may be used to implement some aspects of the invention.

FIG. 1B (PRIOR ART) illustrates an example of a network device that may be configured for implementing some methods of the present invention.

FIG. 2 shows a top view of a gaming table layout on which the present technology may be practiced.

### DETAILED DESCRIPTION OF THE INVENTION

A method of performing a wagering event at a gaming table comprises:
providing a randomized set of at least a single deck of at least 52 playing cards:
   The playing cards are preferably physical playing cards that are provided as random cards throughout the wagering event. The playing cards may also be provided as virtual cards in an electronic system (apparatus or on-line) for enabling the wagering event. More than one deck may be used, as where bonuses against a paytable can pay on 5-of-a-kind.
a player position at the gaming table posting an ante wager;
   This may be an identified (e.g., marked) position at a gaming table or be represented at a table or on-line by a player input system for exercising event options (betting, raising, or folding) and wagering.
the player position posting the ante wager is dealt a first set of two playing cards from the randomized set of playing cards;
   The term “randomized cards” is more generic than literal usage of the term might indicate, mainly because of the nature of apparatus and methods for providing random cards or random hands. Some shuffling or randomization machines, for example, take a full set of playing cards are randomly select individual cards therein for “dealing” (e.g., a random ejection shuffler). Other shuffling devices physically distribute cards within compartments (either randomly or with known suit and rank of cards in each compartment). Random compartments or compartments randomly selected or random cards in compartments are then provided to a delivery tray. All of these variations are included within the scope of randomized cards, even though (especially with the random ejection shuffler) the set of cards are not randomized before provision of individual random cards. In a virtual system, a random number generator or templates of cards in each hand that is stored in memory may be used.
a dealer position is dealt a first set of two playing cards face-down;
   A physical location on the gaming table may be provided. In an electronic system, the dealer position cards would be displayed in a defined area on a monitor.
a community card position on the gaming table is dealt five playing cards face-down;
   A physical location on the gaming table may be provided. In an electronic system, the community position cards would be displayed in a defined area on a monitor.
the player position: a) makes a first play wager of at least 1× (preferably within an available range of 1× or 2×) the ante wager or b) folds and the ante wager is forfeit to the dealer position, with the game ending;
   On a gaming table, specific wagering positions for each wager, at each player position, should be specifically marked on the gaming table, even with alphanumeric elements defining the nature of the wager to be placed at each position.
upon making the play wager of a), three of the five community cards are revealed as a flop;
after the three of five community cards have been revealed the player position: c) makes a final play wager of at least 2× the ante wager (preferably, the player position my make a 2×, 3× or 4× wager) or b) folds and both the ante wager and first play wager are forfeit to the dealer position, with the game ending;
upon making the play wager of c) remaining face-down ones of the five community cards are revealed as a flop, and the dealer position two face-down cards are revealed;
best five-of-seven poker hand rank including the player position first set of two playing cards and the five community cards is compared with the dealer position two playing cards and the five community cards are compared; and
when the dealer position best five-of-seven poker rank is less than an at least a predetermined minimum rank, only the ante wager and the first play wager are at risk according to:
i) if the five-card poker rank at the player position equals the five-card poker rank at the dealer position, at least one of the ante wager and the first play wager and the final play wager is a push,
ii) if the five-card poker rank at the player position exceeds the five-card poker rank at the dealer position, only the ante wager and the first play wager are awarded as a winning outcome, and
iii) if the five-card poker rank at the player position is lower in rank than the five-card poker rank at the dealer position, at least both the ante wager and the first play wager are collected by the dealer;
   and when the dealer position best five-of-seven poker rank exceeds at least a predetermined minimum rank, all of the ante wager, the first play wager and the final play wager are at risk according to:
iv) if the five-card poker rank at the player position equals the five-card poker rank at the dealer position, at least one of the ante wager and the first play wager and the final play wager is a push,
v) if the five-card poker rank at the player position exceeds the five-card poker rank at the dealer position, all of the ante wager, the first play wager and the final play wager are awarded as a winning outcome, and
vi) if the five-card poker rank at the player position is lower in rank than the five-card poker rank at the dealer position, all the ante wager and the play wagers are collected by the dealer.

Many variations within the generic scope of this technology may be practiced. For example, when the flop or the total five community cards has a pair, the dealer may be required to have at least two pair to “qualify” as an at least minimum rank in the performance of the process. Among other variations are the method wherein the first play wager is between 1× and 2× of the ante wager, the final play wager is between 2× and 4× of the ante wager, the dealer best five-of-seven poker hand at least minimum rank is a pair, the at least minimum rank is a pair of 5's, 6's, 7's, 8's, 9's, 10's, J's, Q's, K's or Aces, or the at least minimum rank is a pair of 2's, 3's, 4's, 5's, 6's, 7's, 8's, 9's, 10's, J's, Q's, K's or Aces. The randomized set of playing cards are physical playing cards manually dealt to each position from a randomized complete set of fifty-two playing cards, wherein the playing cards are physical playing cards mechanically delivered to a delivery tray from an electromechanical shuffling device that randomizes a complete set of fifty-two playing cards, the playing cards are physical playing cards mechanically delivered to a delivery tray from an electromechanical shuffling device that randomly provides individual playing cards for delivery to positions on the gaming table, or the randomized set of playing cards are physical playing cards mechanically delivered to a delivery tray from an electromechanical shuffling device that provides appropriate numbers of random playing cards for delivery to positions on the gaming table.

The method may also be executed wherein the randomized set of playing cards are virtual playing cards displayed on a display monitor on a surface of a gaming table comprising a visual display at the player position. The gaming table may further comprise a processor with associated memory and a random number generator, wherein the virtual playing cards are randomly selected for viewing by the random number generator identifying individual virtual cards to be displayed on the visual display.

Super Texas Hold'Em™—a Specific Game within the Scope of the Present Technology
1. The player posts a Blind wager.
2. The dealer receives two down cards. The player also receives two down cards. The dealer deals five community cards face down, to be used by both the player and dealer.
3. Pre-flop. The player can bet 1×-2× the Blind wager or fold. If the player folds, the player forfeits the Blind wager. If the player bets, the dealer reveals the first three community cards a.k.a. the “Flop”.
4. The Flop. The player position can bet 2×-4× the value of the Blind wager or the player position must fold. If the player folds, the player forfeits all wagers. If the player bets, the dealer turns up his hole cards, and reveals the final two community cards.
5. Showdown. The dealer always plays against the Blind and Pre-flop wagers. The dealer only plays against the Flop wager if the dealer has a pair-or-better, unless there is an open pair on the board (i.e. among the community cards), in which case the dealer must have two pair or better to pay the Flop wager.
6. All wagers pay even money, though bonuses may be paid for certain hands. For example, the Blind wager might pay more if the player makes a straight or better. Alternatively, the Flop wager may pay a bigger amount if the player makes a straight-or-better and beats the dealer (for example).

### Super Texas Hold'Em™: The Game, the Math, and the Strategy

Super Texas Hold'Em™ game is dramatically different from the incumbent Hold'em variations. First, the player faces two progressively larger bet-or-fold situations (bet 1×-2×-or-fold pre-flop, and then bet 2×-4×-or-fold on the flop). In addition, the emphasis on wagering is placed squarely on the flop, rather than pre-flop. Lastly, while the dealer always plays against the player's Blind and Pre-flop wagers, the dealer will only play against the player's Flop wager if the dealer makes a pair or better (two pair or better if the board is paired). This last rule turns out to be very sound, and also has a material impact on the player's strategy.

One way that Super Texas Hold'Em™ game works is that when the player places the Blind bet, both the dealer and player get two hole cards. The dealer effectively (but not physically) bets 1× pre-flop; the player can then either call (bet 1×) or raise (bet 2×). At this point, if the player raises (bets 2×), the dealer is effectively getting 5:1 to call and is always correct to play (which the dealer is forced to do anyway).*

Adding value to the dealer is the fact that the player will fold some hands pre-flop, forfeiting his Blind wager; and will also call some hands and then fold on the flop, forfeiting those wagers.

*Essentially, the player posts a 1-unit blind, which the dealer effectively matches; the dealer effectively bets 1×, and the player raises to 2×, effectively putting a total of 5 units in the pot, at which point the dealer must call 1× to match the raise.

The dealer is always correct to play, and this creates a series of tradeoffs.
1. The dealer will always play against player's Blind and Pre-flop wagers (Advantage: Player).
2. The player can bet 1× or 2× Pre-flop (Advantage: Player).
3. The dealer is always correct to play against the player, as the player cannot price the dealer out of the hand (Advantage: Dealer).
4. The dealer never has to fold, and always gets to showdown (Advantage: Dealer).
5. The player will sometimes fold pre-flop (Advantage: Dealer).
6. The player will sometimes call pre-flop and then fold the flop (Advantage: Dealer)
7. The player can bet 2×-4× on the Flop (Advantage: Player).
8. The dealer only plays against the Flop wager if the dealer has a pair or better (Advantage: Dealer).

### The Impact of the Flop Qualifier on Strategy

One example is where the player is dealt 6-6. In most (perhaps all) Hold'em variants (and also Mississippi Stud), the play is generally to bet as much as possible.

For example, in Ultimate Texas Hold'Em™ game, the play would bet to bet the 4× max pre-flop. In Texas Hold'Em™ game Bonus, the play would be to make the 2× pre-flop wager, and probably bet 1× on the flop (the Turn wager) and turn (the River wager) depending on the board. In either World Poker Tour All-In Hold'Em™ poker variation, the play would be to bet the maximum allowed.

Similarly, in Mississippi Stud™ poker, the play would be to bet the maximum 3× blind on all three betting rounds—the 3^{rd} Street, 4^{th} Street, and 5^{th} Street wagers—as the player is free-rolling, where a pair of sixes pushes, and the player can win a substantial amount if he improves to two pair or better.

Super Texas Hold'Em™ game is different. In Super Texas Hold'Em™ game, the play when dealt pocket 6-6 is likely to make the 2× raise pre-flop. However, the player is not likely to be able to make the 4× max bet on the flop blind. This is likely because the dealer will only play against the Flop wager with a pair or better.

Let's say the flop comes A [symbol] J♡7♦, giving the player a bare under-pair with his pair of sixes. The player cannot bet 4× here, as the only ways the dealer can make a pair (or better) and lose to the player are:
1. If the dealer has 2-2, 3-3, 4-4, or 5-5 in the hole and does not improve.
2. The dealer makes a smaller pair, and loses to 6-6.
3. The dealer has a bigger pair (or better), but the player manages to improve on his 6-6.

These are slim possibilities.

Alternatively, consider the circumstance when the player has 2-2. In this case, unless the player improves, the player cannot win on his Flop wager, because the dealer will never play against the Flop wager with anything less than a pair of twos. Thus, rather than bet the 4× maximum, the player's play is likely to bet the 2× minimum and hope to win the Blind and Pre-flop wagers. And in a sense, because the dealer does not play against the Flop wager with anything less than a pair, the player is often laying odds. This may allow us room to pay the Flop wager according to paytable, where bigger hands get bigger payoffs, thus allowing for a unique combination of scalable betting and scalable payoffs among Hold'em variants.

One important aspect to consider is that the dealer always plays against the Blind (ante) and Pre-flop (first play) wagers, but only plays against the Flop wager (final play wager) with a pair or better (unless there is an open pair on the board—among the community cards—in which case the dealer must have two pair or better to play).

The game may be played with physical playing cards or with virtual electronic gaming apparatus, mixed physical and electronic systems or on-line electronic gaming systems.

This method may use physical playing cards wherein the randomization is effected by shuffling of the physical playing cards, as by manual shuffling or an electromechanical shuffler. The physical playing cards are preferably a single deck of physical playing cards and randomization is effected by automated electromechanical shuffling of the physical playing cards. The playing cards may be virtual playing cards and the method is performed on a system comprising a processor, a video display screen and player input controls and the processor displays hands at a virtual player position and a virtual dealer position and a random number generator provides random individual cards for the first subset of playing cards and the second subset of playing cards. The set of playing cards should comprise at least a standard deck of playing cards, fifty-two cards having four suits (spades, hearts, diamonds and clubs) having ranks from 2 to Ace. Multiple decks and/or specialty cards may also be included with the deck. The deck(s) must be randomized by shuffling to provide cards in a random order. The transformation of cards into a random order must be done before the play of each round of the game so that the cards provided cannot be predicted with any significant degree of certainty. The dealer controls the play of the game and dictates the rules of play of the game. The dealer will not allow cards to be dealt to player positions unless the appropriate wager is verified by the dealer. The dealer segments the shuffled set of playing cards into random content subsets of exactly the number of cards that the dealer must provide in each step of the method. The cards may be manually dealt or automatically dealt by a shuffling apparatus. The shuffling apparatus may be a batch shuffler or a continuous shuffler. Cards may be provided one at a time from a delivery position in the shuffler, entire randomized deck(s) may be provided from the shufflers, or individual hands of exactly three cards for delivery to individual player positions and the dealer position. There are a number of variations in the play of the game that may be used.

The shuffling may be performed by a number of various methods, including manual shuffling to produce a randomized set of playing cards. The automatic shufflers may operate by either actually shuffling a portion of or entire set of playing cards (e.g., one or more decks of playing cards), or by providing hands or subsets of playing cards randomly out of the original complete set of playing cards. The cards may be batch shuffled or continuously shuffled (returned, spent cards from previous hands are returned to the machine and randomly distributed among cards already in the machine). The shuffling mechanism may be accomplished by use of carousels (or linear moving stacked arrays) of multiple compartments into which cards are inserted (randomly or in predetermined locations among the compartments) and then unloaded from the compartments (randomly or in predetermined order of compartments) so that random hands or subsets of playing cards are distributed to a delivery area for distribution by the dealer.

The cards may also be delivered to a delivery tray by random removal (e.g., random ejection as understood in the art, or random removal by any other technology) from the original set and delivery of the randomly withdrawn/removed cards to the delivery tray to form random hands or random subsets in the delivery tray.

The game may also be played as a video gaming system, with either a single player terminal or multiple player terminals against a dealer hand.

Multiplayer playstations with 4-7 players at seats before a virtual dealer on a screen may also be used.

### Computer-Based Implementations

Methods of the present invention may be implemented in computer hardware, software, or computer hardware and software. A most common form of computer implementation is a stand-alone, single player electronic gaming machine with electronic player controls and one or more video output screens.

In computer-based embodiments, the gaming device preferably includes at least one processor, such as a microprocessor, a microcontroller-based platform, a suitable integrated circuit or one or more application-specific integrated circuits (ASIC's) or Field Programmable Gated Arrays (FPGA's). The processor is in communication with or operable to access or to exchange signals with at least one data storage or memory device, and/or a player monitor or monitors. In one embodiment, the processor and the memory device reside within the cabinet of a gaming device. Multiple gaming devices are typically connected to a casino information network.
The memory device stores program code and instructions, executable by the processor, to control the gaming device. The memory device also stores other data such as image data, event data, player input data, random or pseudo-random number generators, pay-table data or information, House Ways distributions and applicable game rules that relate to the play of the gaming device. In one embodiment, the memory device includes random access memory (RAM): which can include non-volatile RAM (NVRAM): magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.
In one embodiment, part or all of the program code and/or operating data described above can be stored in a detachable or removable memory device, including, but not limited to, a suitable cartridge, disk, CD ROM, DVD, or USB memory device.
In other embodiments, part or all of the program code and/or operating data described above can be downloaded to the memory device through a suitable network. In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. The gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “processor” or “computer” or “controller” or “game controller.”
In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome. It is also possible for templates or weighted templates of sets of tiles or paylines as disclosed in U.S. Pat. Nos. 6,159,096 and 6,117,009 (Yoseloff, which are incorporated by reference in their entirety) which disclose a method of configuring a video output gaming device to randomly generate game outcomes. The method includes the steps of selecting a set of game symbols, assigning a probability of occurrence to each symbol, selecting a plurality of outcome templates, each template comprising X variables, selecting a probability of occurrence for each outcome template, assigning a subset of symbols from the set of game symbols to each template for filling the positions, defining payouts for selected outcomes, and configuring a video output gaming device, which randomly selects a template, randomly selects a symbol for each variable in the template from the subset of game symbols assigned to the selected template, randomly fills at least a portion of the positions in the template and displays the outcome on a video output display. A video output gaming device programmed to randomly select a template, randomly select symbols to define the variables and randomly display the selected symbols is also disclosed.

In one embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure. This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display 20 which displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.
In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.
In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.
Other forms of the invention are in the form of game software that is implemented in a variety of formats, such as internet gaming, PC practice play, hand-held game devices, wireless gaming devices and the like.

### Chipless Gaming Table Implementation

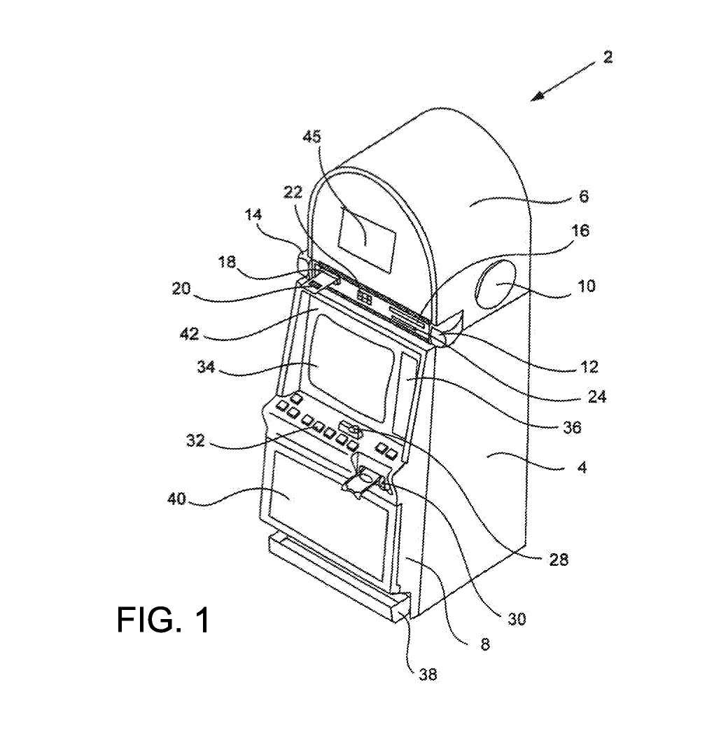

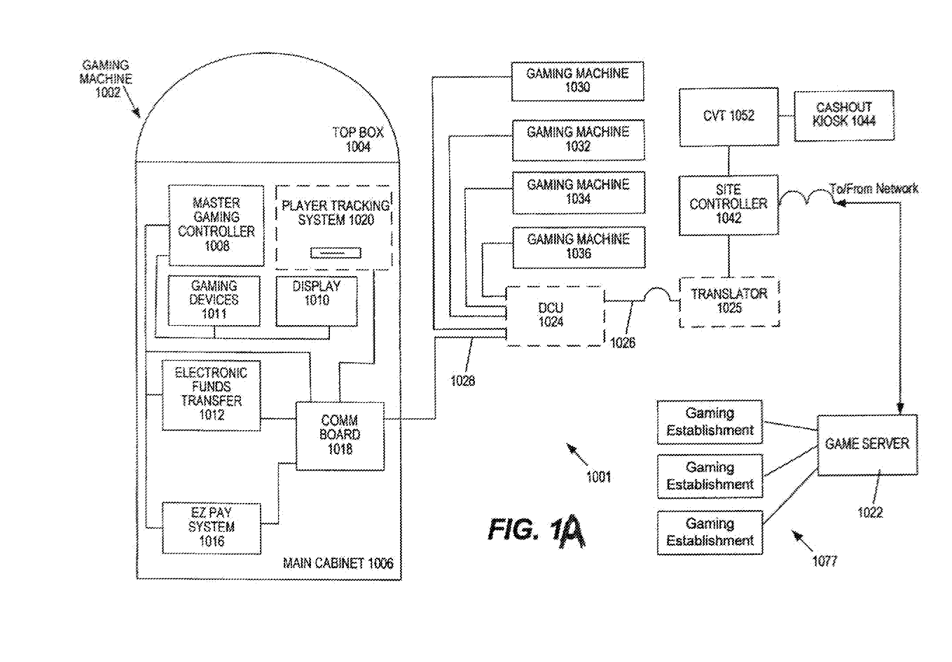

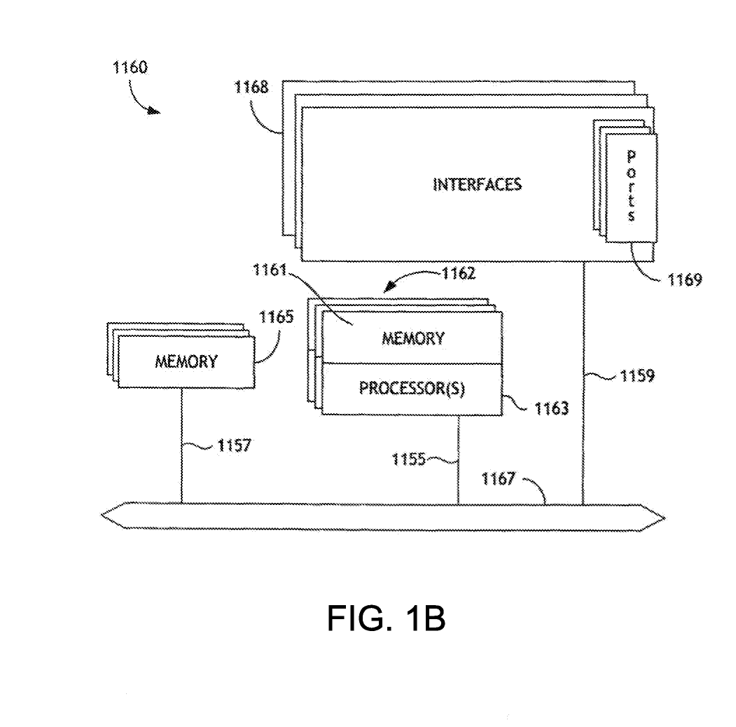

One enabling system useful in the practice of the present invention is the use of playing cards with Chinese domino symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game rules, hand history, and the like.
With regard to software f), it is understood in the practice of the present technology that this is not complex software that reads individual player hand cards and determines advantageous card distributions for a first time by extensive calculations.
A preferable card handling device for administering a video or even reel-type-style game is a hand-forming shuffler with integrated card recognition technology, from which playing cards are supplied, with a least a rank/count (and preferable also suit) of individual packs of cards are known before the cards are removed and delivered to player positions and/or the dealer position. The card delivery system 102 is in communication with the controller 128 by wired or wireless communication methods. Communication between the various system components is not limited to electronic or electrical signals, but may include optical signals, audio signals, magnetic transmission or the like.
The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.
Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.
Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.
The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.
The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.
At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.
For the purposes of illustration, a few differences between PC systems and gaming systems will be described. A first difference between gaming machines and common PC based computers systems is that gaming macchines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.
A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator, Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.
A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.
Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.
To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.
A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.
Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include, voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.
The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.
In general, the gaming machine does not advance from a first state to a second state until critical information that allows the first state to be reconstructed is stored. This feature allows the game to recover operation to the current state of play in the event of a malfunction, loss of power, etc, that occurred just prior to the malfunction. After the state of the gaming machine is restored during the play of a game of chance, game play may resume and the game may be completed in a manner that is no different than if the malfunction had not occurred, Typically, battery backed RAM devices are used to preserve this critical data although other types of non-volatile memory devices may be employed. These memory devices are not used in typical general-purpose computers.
As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.
Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.
Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.
The serial interfaces may be used to transmit information using communication protocols that are unique to the gaming industry. For example, the Netpiex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.
Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate of detect unique device addresses. General-purpose computer serial ports are not able to do this.
Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.
Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader, During the game, the player views game information using the video display 34, Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14, Visual effects include flashing lights, strobing lights or other patterns displayed from lights on the gaming machine 2 or from lights within the separate mechanical for electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.
The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.
A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020.
The systems of the gaming machine 1002 communicate the data onto the network 1022 via a communication board 1018.
It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.
Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.
In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.
Further, in some dedicated gaming networks, the DCU 1024 can receive data transmitted from site controller 1042 for communication to the gaming machines on the gaming network. The received data may be, for example, communicated synchronously to the gaming machines on the gaming network.
Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.
When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.
CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.
Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.
Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.
Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

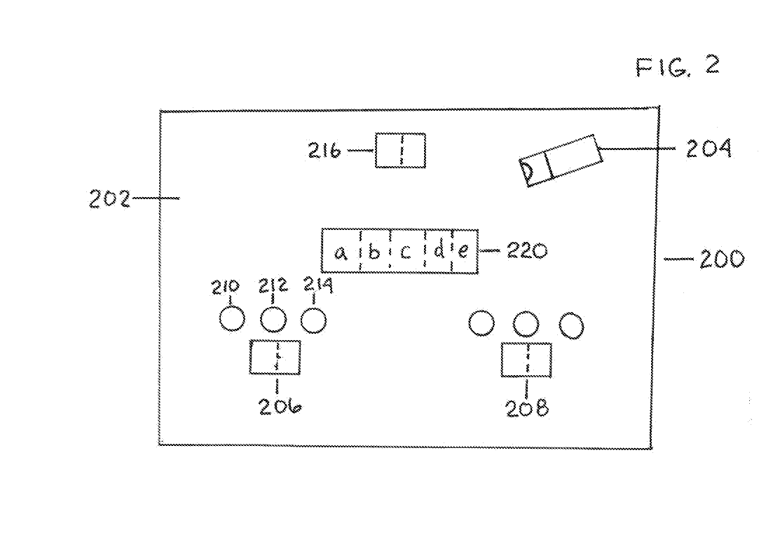

FIG. 2 shows a top view of a gaming table layout 200 on which the present technology may be practiced. The Table layout 200 has a table surface 202 on which is displayed a randomized card delivery device 204 and a first player card receiving position 206 and a second player card receiving position 208. At the first player card receiving position 206 there is shown three distinct wagering area, the Ante wager position 210, the first Play wager position 212 and the final Play wager position 214. Also shown is the dealer position for receiving playing cards 216 and the community playing card receiving position 220. At the community playing card receiving position 220 are positions for the flop a b c and the final two cards c d for the community playing card position 220.

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

What is claimed:

1. A method of performing a wagering event at a gaming table comprises:
providing a randomized set of at least a single deck of at least 52 playing cards:
a player position at the gaming table posting an ante wager;
the player position posting the ante wager is dealt a first set of two playing cards from the randomized set of playing cards;
a dealer position is dealt a first set of two playing cards face-down;
a community card position on the gaming table is dealt five playing cards face-down;
the player position: a) makes a first play wager of at least 1× the ante wager or b) folds and the ante wager is forfeit to the dealer position, with the game ending;
upon making the play wager of a), three of the five community cards are revealed as a flop;
after the three of five community cards have been revealed the player position: c) makes a final play wager of at least 1× the ante wager or d) folds and both the ante wager and first play wager are forfeit to the dealer position, with the game ending;
upon making the play wager of c) remaining face-down ones of the five community cards are revealed as a flop, and the dealer position two face-down cards are revealed;
best five-of-seven poker hand rank including the player position first set of two playing cards and the five community cards is compared with the dealer position two playing cards and the five community cards are compared; and
when the dealer position best five-of-seven poker rank is less than an at least a predetermined minimum rank, only the ante wager and the first play wager are at risk according to:
i) if the five-card poker rank at the player position equals the five-card poker rank at the dealer position, at least one of the ante wager and the first play wager and the final play wager is a push,
ii) if the five-card poker rank at the player position exceeds the five-card poker rank at the dealer position, only the ante wager and the first play wager are awarded as a winning outcome, and
iii) if the five-card poker rank at the player position is lower in rank than the five-card poker rank at the dealer position, at least both the ante wager and the first play wager are collected by the dealer;
and when the dealer position best five-of-seven poker rank exceeds at least a predetermined minimum rank, all of the ante wager, the first play wager and the final play wager are at risk according to:
iv) if the five-card poker rank at the player position equals the five-card poker rank at the dealer position, at least one of the ante wager and the first play wager and the final play wager is a push,
v) if the five-card poker rank at the player position exceeds the five-card poker rank at the dealer position, all of the ante wager, the first play wager and the final play wager are awarded as a winning outcome, and
vi) if the five-card poker rank at the player position is lower in rank than the five-card poker rank at the dealer position, all the ante wager and the play wager are collected by the dealer.

2. The method of claim 1 wherein the first play wager is between 1× and 2× of the ante wager.

3. The method of claim 1 wherein the final play wager is between 2× and 4× of the ante wager.

4. The method of claim 2 wherein the final play wager is between 2× and 4× of the ante wager.

5. The method of claim 1 wherein when the dealer best five-of-seven poker hand at least minimum rank is a pair.

6. The method of claim 1 wherein when the dealer best five-of-seven poker hand at least minimum rank is a pair of 5's, 6's, 7's, 8's, 9's, 10's, J's, Q's, K's or Aces.

7. The method of claim 5 wherein when the dealer best five-of-seven poker hand at least minimum rank is a pair of 2's, 3's, 4's, 5's, 6's, 7's, 8's, 9's, 10's, J's, Q's, K's or Aces.

8. The method of claim 2 wherein the randomized set of playing cards are physical playing cards manually dealt to each position from a randomized complete set of fifty-two playing cards.

9. The method of claim 2 wherein the randomized set of playing cards are physical playing cards mechanically delivered to a delivery tray from an electromechanical shuffling device that randomizes a complete set of fifty-two playing cards.

10. The method of claim 2 wherein the randomized set of playing cards are physical playing cards mechanically delivered to a delivery tray from an electromechanical shuffling device that randomly provides individual playing cards for delivery to positions on the gaming table.

11. The method of claim 2 wherein the randomized set of playing cards are physical playing cards mechanically delivered to a delivery tray from an electromechanical shuffling device that provides appropriate numbers of random playing cards for delivery to positions on the gaming table.

12. The method of claim 2 wherein the randomized set of playing cards are virtual playing cards displayed on a display monitor on a surface of a gaming table comprising a visual display at the player position.

13. The method of claim 12 wherein the gaming table further comprises a processor with associated memory and a random number generator, wherein the virtual playing cards are randomly selected for viewing by the random number generator identifying individual virtual cards to be displayed on the visual display.

14. The method of claim 5 wherein when the three of five community cards first revealed includes a pair, then the dealer best five-of-seven poker hand at least minimum rank is two pair.

15. The method of claim 4 wherein when the three of five community cards first revealed includes a pair, then the dealer best five-of-seven poker hand at least minimum rank is two pair.

16. The method of claim 9 wherein when the three of five community cards first revealed includes a pair, then the dealer best five-of-seven poker hand at least minimum rank is two pair.

17. The method of claim 5 wherein when the five community cards revealed includes a pair, then the dealer best five-of-seven poker hand at least minimum rank is two pair.

18. The method of claim 4 wherein when the five community cards revealed includes a pair, then the dealer best five-of-seven poker hand at least minimum rank is two pair.

19. The method of claim 9 wherein when the five community cards revealed includes a pair, then the dealer best five-of-seven poker hand at least minimum rank is two pair.
